(19) United States
(12) Patent Application Publication
(10) Pub. No.: US 2017/0337727 A1
(43) Pub. Date: Nov. 23, 2017

(54) DIGITAL SURFACE RENDERING

(71) Applicant: International Business Machines Corporation, Armonk, NY (US)

(72) Inventor: Samir K. Dash, Bangalore (IN)

(21) Appl. No.: 15/672,394

(22) Filed: Aug. 9, 2017

Related U.S. Application Data
(63) Continuation of application No. 15/058,249, filed on Mar. 2, 2016.

(51) Int. Cl. G06T 15/04; F21S 10/02; G09F 9/30; F21V 9/10; F21Y 2115/10

(52) U.S. Cl. CPC G06T 15/04; F21S 10/02; G09F 9/301; F21Y 2115/10; F21V 9/10

(57) ABSTRACT

A method for digital surface rendering. The method includes providing a programmable display covering a portion of a surface of an object. The method further includes receiving a set of desired features for an appearance of the object. The method further includes generating an image of the portion of the surface of the object incorporating the set of desired features and displaying the image on the programmable display, thereby causing the object to appear to have the desired features.

### BACKGROUND

The present invention relates generally to the field of display technology, and more particularly to rendering images on item surfaces.

A display device is an output device for presentation of information in visual form. Commonly used display technologies include, light-emitting diodes (LED), organic light-emitting diodes (OLED), liquid crystal displays (LCD), and in-place switching LCD (IPS-LCD).

Electronic ink (e-Ink) is a paper-like display technology, characterized by high brightness and contrast, a wide viewing angle, and ultra-low power requirements. E-Ink is processed into a film for integration into electronic displays and has enabled novel applications in phones, watches, magazines and e-readers. E-Ink displays are also referred to as “reflective displays”. In an E-Ink display, no backlight is used to emit light; rather, ambient light from the environment is reflected from the surface of the display back to a viewer's eyes. The surface of E-Ink displays, and as with any reflective surface, the more ambient light, the brighter the display looks. This attribute allows E-Ink to mimic traditional ink and paper.

### SUMMARY

Embodiments of the present invention disclose a method, computer program product, and system for digital surface rendering. The method includes providing a programmable display covering a portion of a surface of an object. The method further includes receiving a set of desired features for an appearance of the object. The method further includes generating an image of the portion of the surface of the object incorporating the set of desired features and displaying the image on the programmable display, thereby causing the object to appear to have the desired features.

### BRIEF DESCRIPTION OF THE DRAWINGS

FIG. 1 is a functional block diagram illustrating an image rendering environment, in an embodiment in accordance with the present invention.

FIG. 2 is a functional block diagram illustrating one implementation for image rendering on a vehicle surface within the image rendering environment of FIG. 1, in an embodiment in accordance with the present invention.

FIG. 3 is a functional block diagram illustrating various user interfaces for rendering images on a vehicle surface within the image rendering environment of FIG. 1, in an embodiment in accordance with the present invention.

FIG. 4 is a flowchart depicting operational steps of a rendering software, on a vehicle within the image rendering environment of FIG. 1, for receiving and rendering images on a vehicle surface, in an embodiment in accordance with the present invention.

FIGS. 5A-5C are functional block diagrams illustrating a real time rendering of a background on a vehicle surface within the image rendering environment of FIG. 1, in an embodiment in accordance with the present invention.

FIG. 6 is a flowchart depicting operational steps of a rendering software, on a vehicle within the image rendering environment of FIG. 1, for real time rendering of a background on a vehicle surface, in an embodiment in accordance with the present invention.

FIG. 7 depicts a block diagram of components of the computer executing the rendering software, in an embodiment in accordance with the present invention.

### DETAILED DESCRIPTION

Embodiments in accordance with the present invention recognize that consumers evaluate products based on certain parameters such as brand names, quality, performance, and appearance. For example, the color of a product may have a significant role in a decision to purchase the product. Also, once the user decides the color and purchases the product, he/she may change his/her mind and regret being stuck with the color. For low priced items, there are some option choices, such as different product coverings, wrappings, themes, or designer shells. But this is not applicable to many high end products such as cars or refrigerators. For many consumers, staying ahead in fashion trends matters the most when it comes to buying products. Embodiments of the present invention provide an approach where consumer goods and personal vehicles such as cars and/or bikes can change appearance dynamically by a user's instruction and/or preference.

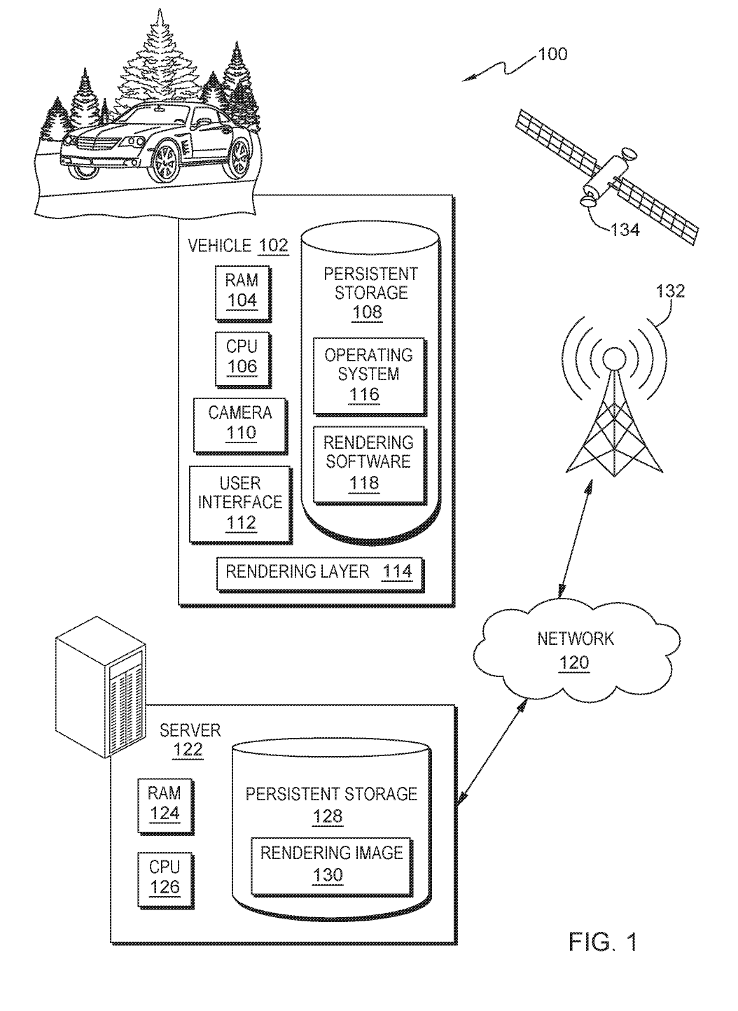

Embodiments in accordance with the present invention will now be described in detail with reference to the Figures. FIG. 1 is a functional block diagram, generally designated 100, illustrating an image rendering environment, in an embodiment in accordance with the present invention.

Image rendering environment 100 includes vehicle 102, server 122, cell tower 132, satellite 134 and other computing devices (not shown), all interconnected over network 120. Vehicle 102 includes random access memory (RAM) 104, central processing unit (CPU) 106, persistent storage 108, camera 110, user interface 112 and rendering layer 114. Vehicle 102 may contain a Web server, or any other electronic device or computing system, capable of processing program instructions and receiving and sending data. In some embodiments, components of vehicle 102 may include a laptop computer, a tablet computer, a netbook computer, a personal computer (PC), a desktop computer, a personal digital assistant (PDA), a smart phone, or any programmable electronic device capable of communicating over a data connection to network 120. In other embodiments, vehicle 102 may utilize multiple server computing systems comprised of multiple computers as a server system, such as in a distributed computing environment. In general, vehicle 102 is representative of any electronic device or combinations of electronic devices capable of executing machine-readable program instructions and communicating with server 122 via network 120 and with various components and devices (not shown) within image rendering environment 100.

Vehicle 102 includes persistent storage 108. Persistent storage 108 may, for example, be a hard disk drive. Alternatively, or in addition to a magnetic hard disk drive, persistent storage 108 may include a solid state hard drive, a semiconductor storage device, read-only memory (ROM), erasable programmable read-only memory (EPROM), flash memory, or any other computer-readable storage medium that is capable of storing program instructions or digital information. Rendering software 118 is stored in persistent storage 108, which enables vehicle 102 to receive and render images on rendering layer 114. Persistent storage 108 also includes operating system 116 that allows vehicle 102 to communicate with server 122 and other computing devices (not shown) of image rendering environment 100 over a data connection on network 120. In other example embodiments, rendering software 118 may be a component of operating system 116.

Rendering software 118 is a computer program, or a set of computer programs, that are stored in persistent storage 108. Rendering software 118 enables a user to change the color of vehicle 102. Rendering software 118 may also receive and render photographs, advertisements, custom designs logos, text and/or patterns on vehicle 102 using user interface 112 or via a mobile device or other electronic device executing a version of rendering software 118.

Camera 110 is also included in vehicle 102 and is used to capture images to display on rendering layer 114 to allow vehicle 102 to blend in to with the surrounding area. In one example embodiment, camera 110 continuously captures and displays images of the area behind vehicle 102, to make vehicle 102 blend in with the surrounding environment. For example, a user of vehicle 102 may park at a scenic overlook. Vehicle 102 may be preventing other people from having a clear view of the scenery. The user of vehicle 102 may then enable rendering software 118 and camera 110 to continuously capture the view that is being obstructed by vehicle 102 and render the real time image on rendering layer 114. In another example embodiment, camera 110 may be used by a user of vehicle 102 to replicate the color of another vehicle, or any color or image of the user's liking. For example, a user of vehicle 102 may like the color of another vehicle. The user may manually focus camera 110 on the desired color (e.g., the other vehicle) and capture an image of the color. Rendering software 118 processes the captured image and displays the new color on rendering layer 114. In other example embodiments, camera 110 may capture images from multiple directions. Images obtained by camera 110 from multiple directions may be used to render different images to various surfaces of vehicle 102. For example, camera 110 is mounted on a 3-axis gimbal and captures images from all sides of vehicle 102 to make vehicle 102 blend in with the surrounding area from all angles. In another example, camera 110 is comprised of an array of cameras distributed across vehicle 102 that may obtain images from a hemispherical area around vehicle 102, which may include beneath vehicle 102.

Vehicle 102 also includes user interface 112. User interface 112 is a program that provides an interface between a user of vehicle 102 and a plurality of applications that may reside in vehicle 102 (e.g., rendering software 118), and/or applications on computing devices that may be accessed over a data connection on network 120. A user interface, such as user interface 112, refers to the information (e.g., graphic, text, sound) that a program presents to a user and the control sequences the user employs to control the program. User interface 112 is a type of interface that allows users to interact with peripheral devices (i.e., external computer hardware that provides input and output for a computing device, such as a keyboard and mouse, or touch control) through graphical icons and visual indicators as opposed to text-based interfaces, typed command labels, or text navigation. The actions in GUIs are often performed through direct manipulation of the graphical elements. A variety of types of user interfaces exist. In one embodiment, user interface 112 is a graphical user interface (GUI). In another embodiment, user interface 112 may be a web user interface (WUI) and can display text, documents, web browser windows, user options, application interfaces, and instructions for operation, and includes the information (such as graphic, text, and sound) that a program presents to a user and the control sequences the user employs to control the program. User interface 112 may also be mobile application software that provides an interface between a user of vehicle 102 and server 122, and other devices (not shown), over a data connection on network 120. Mobile application software, or an “app,” is a computer program designed to run on smart phones, tablet computers and other mobile devices. User interface 112 enables a user of vehicle 102, and rendering software 118, to capture, and/or receive, and render images on rendering layer 114.

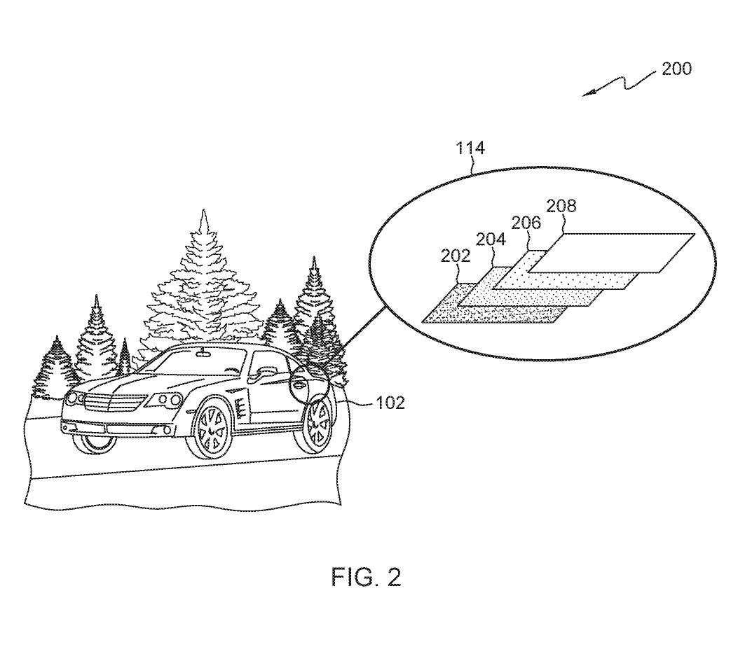

Rendering layer 114 is used to display colors, advertisements, and images from rendering software 118. In one example embodiment, rendering software 118 may receive advertisements based on vehicle 102's global positioning system (GPS) coordinates. For example, when vehicle 102 enters an area with certain restaurants, rendering software 118 may receive advertisement images via satellite 134, or cell tower 132 to be displayed on rendering layer 114. Rendering layer 114 is described in further detail with respect to FIG. 2.

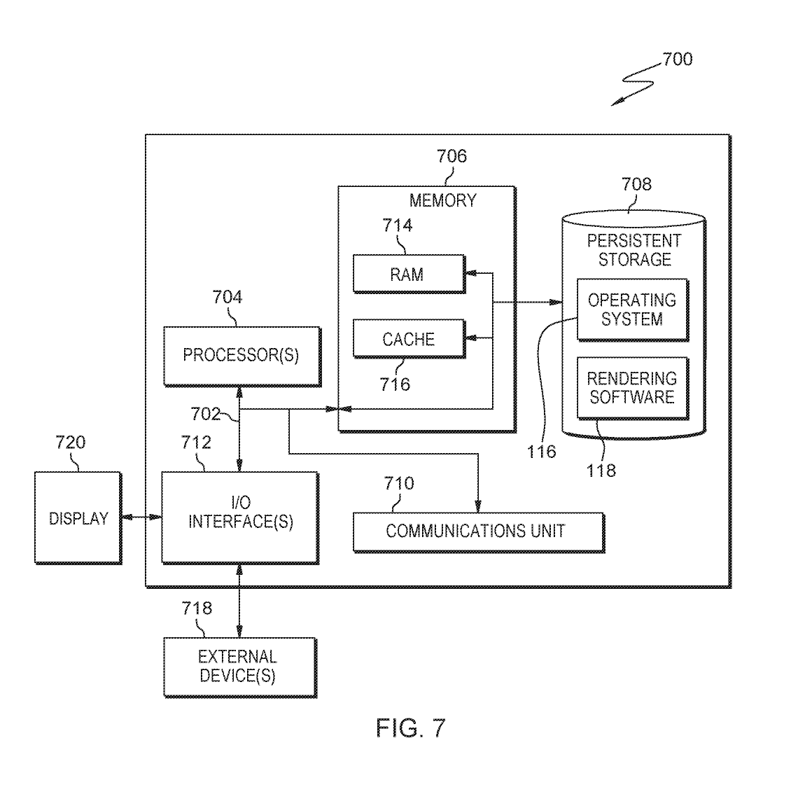

Vehicle 102 may include internal and external hardware components, as depicted and described in further detail with respect to FIG. 7.

In FIG. 1, network 120 is shown as the interconnecting fabric between vehicle 102, server 122, cell tower 132, satellite 134, and with various components and devices (not shown) within image rendering environment 100. In practice, the connection may be any viable data transport network, such as, for example, a LAN or WAN. Network 120 can be, for example, a local area network (LAN), a wide area network (WAN) such as the Internet, or a combination of the two, and include wired, wireless, or fiber optic connections. In general, network 120 can be any combination of connections and protocols that will support communications between vehicle 102, server 122, and with various components and devices (not shown) within image rendering environment 100.

Server 122 is included in image rendering environment 100. Server 122 includes random access memory (RAM) 124, central processing unit (CPU) 126, and persistent storage 128. Server 122 may be a Web server, or any other electronic device or computing system, capable of processing program instructions and receiving and sending data. In some embodiments, server 122 may be a laptop computer, a tablet computer, a netbook computer, a personal computer (PC), a desktop computer, a personal digital assistant (PDA), a smart phone, or any programmable electronic device capable of communicating over a data connection to network 120. In other embodiments, server 122 may represent server computing systems utilizing multiple computers as a server system, such as in a distributed computing environment. In general, server 122 is representative of any electronic devices or combinations of electronic devices capable of executing machine-readable program instructions and communicating with rendering software 118 via network 120 and with various components, such as cell tower 132, satellite 134, and devices (not shown) within image rendering environment 100.

Server 122 includes persistent storage 128. Persistent storage 128 may, for example, be a hard disk drive. Alternatively, or in addition to a magnetic hard disk drive, persistent storage 128 may include a solid state hard drive, a semiconductor storage device, read-only memory (ROM), erasable programmable read-only memory (EPROM), flash memory, or any other computer-readable storage medium that is capable of storing program instructions or digital information. Rendering image 130 is stored in persistent storage 128, which also includes operating system software, as well as software that enables server 122 to detect and establish a connection to vehicle 102, and communicate with other computing devices (not shown) of image rendering environment 100 over a data connection on network 120.

Cell tower 132 is included in image rendering environment 100. A cell tower, also referred to as a cell site, is a cellular telephone site where antennae and electronic communications equipment are placed, usually on a radio mast, tower or other high place, to create a cell (or adjacent cells) in a cellular network. The elevated structure typically supports antennae, and one or more sets of transmitter/receivers transceivers, digital signal processors, control electronics, a GPS receiver for timing, primary and backup electrical power sources, and sheltering. Cell tower 132 is used to transmit and receive digital images and information from rendering software 118 and other applications and/or devices in vehicle 102.

Some cities require that cell sites be inconspicuous. For example, some cities require that cell sites be blended with the surrounding area, or be mounted on buildings or advertising towers to avoid unsightly obstructions. In one example embodiment, rendering layer 114 may be used to conceal cell tower 132 by making the tower appear to be a tall tree.

Satellite 134 is included in image rendering environment 100. A satellite is an artificial object which has been intentionally placed into orbit. Common types of satellites include Earth observation satellites, communications satellites, navigation satellites, weather satellites, and research satellites. Satellite 134 is used to transmit and receive digital images and information from rendering software 118 and other applications and/or devices in vehicle 102.

FIG. 2 is a functional block diagram, generally designated 200, illustrating one implementation for image rendering on a vehicle surface within the image rendering environment of FIG. 1, in an embodiment in accordance with the present invention. In one example embodiment, the surface of vehicle 102 contains rendering layer 114. Rendering layer 114 is comprised of four layers: a protective layer 202, a circuit layer 204, a flexible rendering layer 206, and an anti-scratch touch sensing layer 208. Protective layer 202 is used to provide a protecting layer between the body of vehicle 102 and circuit layer 204 that shields the circuit and/or hardware from vibrations and direct contact with any hard surface that may wear down and cause faults in circuit layer 204. In some embodiments, protective layer 202 includes a reflective coating below circuit layer that enables rendering layer 114 to operate via reflected ambient light. Circuit layer 204 is placed on top of protective layer 202 and receives colors, images, advertisements, and/or text from rendering software 118 to display on flexible rendering layer 206. In one embodiment, circuit layer 204 is controlled by rendering software 118 using wireless technology such as Wi-Fi or Bluetooth. In another embodiment, circuit layer 204 is controlled by rendering software 118 using wired circuits or via universal serial bus (USB) ports. Circuit layer 204 then displays the received colors, images, advertisements, and/or text from rendering software 118 on flexible rendering layer 206. Flexible rendering layer 206 is placed on top of circuit layer 204 and is protected by anti-scratch touch sensing layer 208 and is able to match, or be molded, to the contours of vehicle 102. In one embodiment, flexible rendering layer 206 may be comprised of light emitting diodes (LED), organic light-emitting diodes (OLED), or liquid crystal displays (LCD). For example, flexible rendering layer 206 may be comprised of in-place switching LCDs (IPS-LCD) to provide wider viewing angles and lower power consumption. Anti-scratch touch sensing layer 208 is used to protect circuit layer 204. In one embodiment, flexible rendering layer 206 may incorporate electronic ink (e-Ink) technology to render, or display images on rendering layer 114. The e-ink flexible rendering layer 206 may flex to match the contours and edges of vehicle 102. In another example embodiment, the e-ink flexible rendering layer 206 may be specifically molded to match the contours of the external panels of vehicle 102. Traditional LCD displays incorporate backlight technology that emits light that a viewer can see. However, the backlight can also consume up to 40% of the power used in electronic product. Therefore, eliminating the need for a backlight by incorporating a backlight-free e-ink display can significantly increases battery life over using a traditional LCD.

In one embodiment, anti-scratch touch sensing layer 208 provides touch responses capabilities for vehicle 102, similar to a touch screen of a mobile device. For example, anti-scratch touch sensing layer 208 may enable a user to gain entry into vehicle 102 by displaying a keyless entry keypad on the surface of vehicle 102. The user may enter a combination on the displayed keyless entry keypad to unlock a door. In one example embodiment, anti-scratch touch sensing layer 208 may enable a user to gain entry into vehicle 102 by sensing, or reading, a user's fingerprint or handprint. Upon placing a hand or finger on rendering layer 114, rendering software 118 reads the fingerprint, or handprint, and unlocks a door if the user is authorized. In another example embodiment, anti-scratch touch sensing layer 208 may read the fingerprint or handprint of an individual that attempts unauthorized access to vehicle 102.

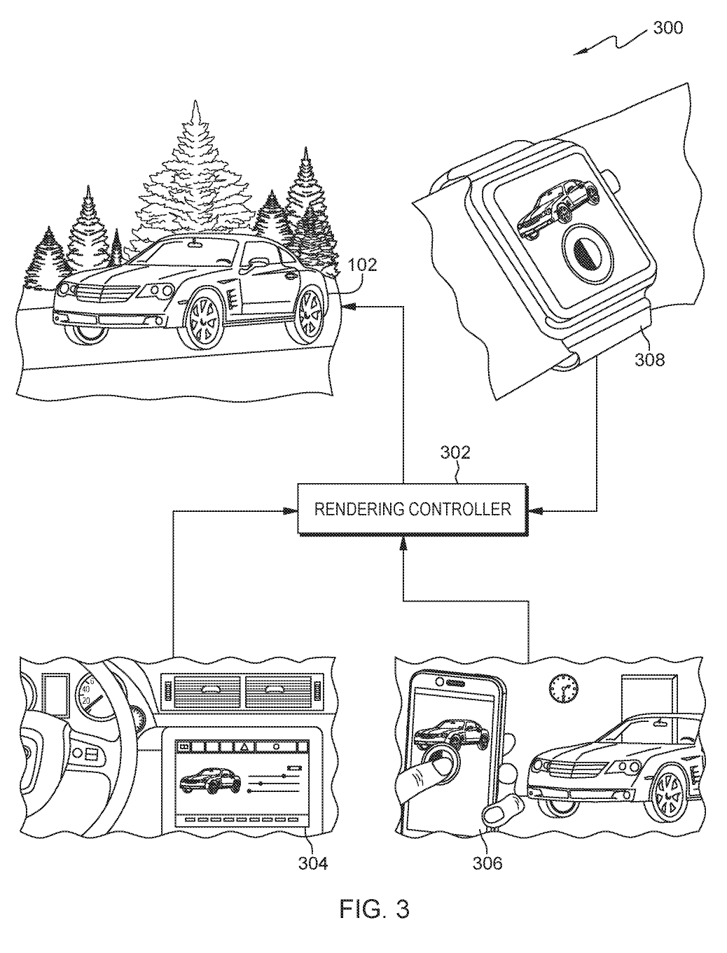

FIG. 3 is a functional block diagram, generally designated 300, illustrating various user interfaces for rendering images on a vehicle surface within the image rendering environment of FIG. 1, in an embodiment in accordance with the present invention. Vehicle 102 includes rendering controller 302 and receives instructions from rendering software 118 to display colors, images, advertisements, and/or text from rendering software 118. In one example embodiment, rendering controller 302 may be a component of a cloud-based rendering system used to deliver colors, images, advertisements, and/or text to registered consumers that may select one or more colors, images, advertisements, and/or text to display on one or more vehicle 102's.

In one example embodiment, a user of vehicle 102 uses an in-dash display, also referred to as user interface 304, to select and customize one or more colors, images, advertisements, and/or text on server 122 to display on rendering layer 114. For example, the user may browse a plurality of categories of rendering image 130 on server 122 and select a desired image using user interface 304. Upon selecting the desired image, rendering software 118 transmits the image to rendering controller 302. Rendering controller 302 then displays the image on rendering layer 114.

In another example embodiment, a user of vehicle 102 uses mobile application 306 to select and customize one or more colors, images, advertisements, and/or text on server 122 to display on rendering layer 114. For example, the user may browse a plurality of categories of rendering image 130 on server 122 and select a desired image using mobile application 306. Upon selecting the desired image using mobile application 306, rendering software 118 transmits the image to rendering controller 302. Rendering controller 302 then displays the image on rendering layer 114.

In other example embodiments, a user of vehicle 102 uses a wearable device, such as wearable device 308, to select and customize one or more colors, images, advertisements, and/or text on server 122 to display on rendering layer 114. For example, the user may browse a plurality of categories of rendering image 130 on server 122 and select a desired image using wearable device 308. Upon selecting the desired image using wearable device 308, rendering software 118 transmits the image to rendering controller 302. Rendering controller 302 then displays the image on rendering layer 114. In an another example embodiment, rendering software 118 receives and responds to a message generated by wearable device 308 that is a health monitor worn by a user of vehicle 102. Wearable device 308 indicates that the user of wearable device 308 is in need of assistance and rendering software 118 may generate a message, or display the received indication from wearable device 308. Rendering software 118 then transfers the message for help to rendering controller 302 which presents a message for help via rendering layer 114 of vehicle 102.

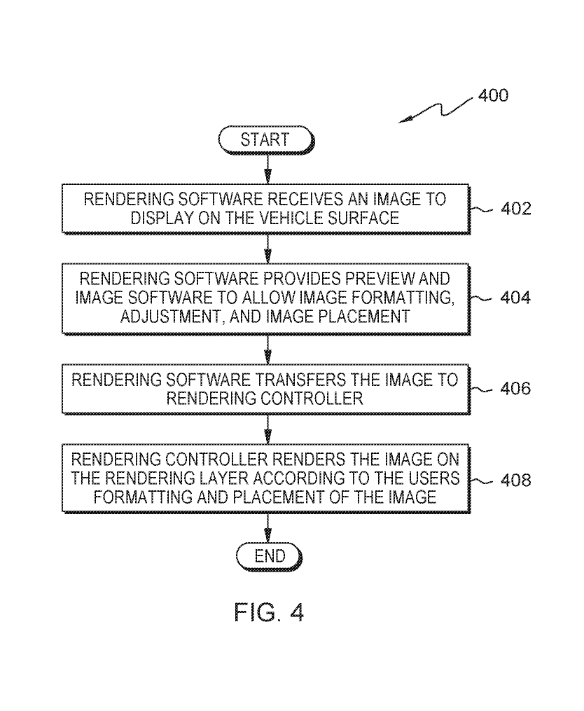

FIG. 4 is a flowchart, generally designated 400, depicting operational steps of an rendering software, on a vehicle within the image rendering environment of FIG. 1, for receiving and rendering images on a vehicle surface, in an embodiment in accordance with the present invention. In one example embodiment, a user of vehicle 102 uses mobile application 306 to browse rendering image 130 on server 122. Upon formatting or customizing rendering image 130, the user accepts the changes and rendering image 130 is transmitted to vehicle 102 via cell tower 132.

Rendering software 118 receives an image to display on the vehicle surface as depicted in step 402. The received image may be captured by camera 110 or transferred from rendering image 130 on server 122 via cell tower 132 and/or satellite 134. In another example embodiment, rendering software 118 may receive rendering image 130 using a Wi-Fi or Bluetooth connection on network 120.

In step 404, rendering software 118 provides preview and image software to allow image formatting, adjustment, and image placement. Upon receiving the image at vehicle 102, rendering software 118 may allow the user to further modify, or customize, the color, image, advertisement, and/or text. For example, the user may decide to add a flower pattern to the downloaded color using user interface 304. Upon previewing rendering image 130, the user may then choose to render, or display, the image on rendering layer 114.

Rendering software 118 transfers the image to rendering controller 302 as depicted in step 406. Rendering controller 302 receives rendering image 130 via a direct wired connection or wirelessly via a Wi-Fi or Bluetooth connection and prepares the image to be displayed on rendering layer 114. In other example embodiments, rendering controller 302 may receive colors, images, advertisements, and/or text manually from a user through using a USB port wherein a user my transfer images using a USB drive, or via a memory card reader. A memory card reader is a device for accessing the data on a memory card such as a CompactFlash (CF), Secure Digital (SD) or MultiMediaCard (MMC).

In step 408, rendering controller 302 renders the image on the rendering layer 114 according to the users formatting and placement of the image. For example, rendering controller 302 determines the placement of the image on rendering layer 114 by taking the contours of vehicle 102 into consideration. This allows the image to look correct to the human eye from any angle or distance. Upon determining the placement of rendering image 130, rendering controller 302 transfers rendering image 130 to circuit layer 204 and flexible rendering layer 206.

In one example embodiment, commercial advertisements may lease an area of a city street and display advertisements, such as a billboard, on passing cars. A plurality of vehicle 102's passing through the leased location are tracked based on GPS coordinates by a cloud-based rendering controller 302. The cloud-based rendering controller 302 continuously transmits and updates the billboard on the determined location the plurality of vehicles pass through the leased location to make the billboard appear in one spot as the plurality of vehicle 102's pass.

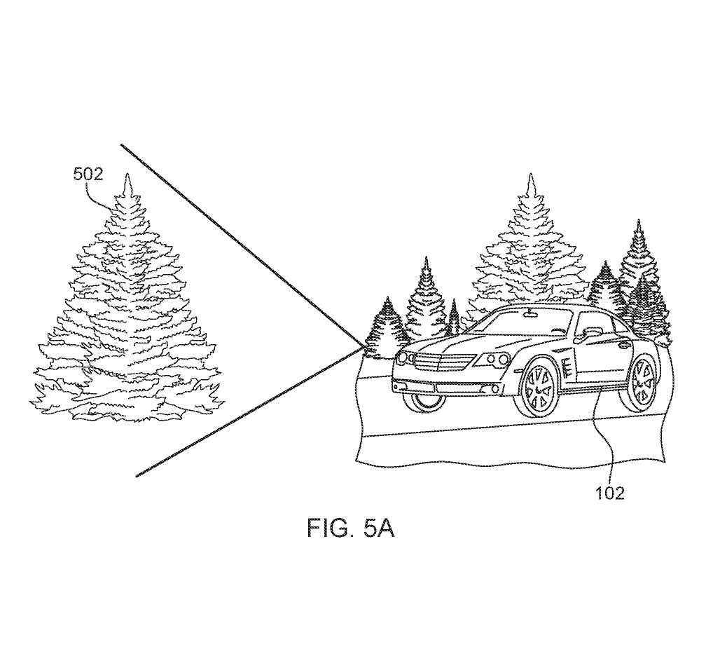

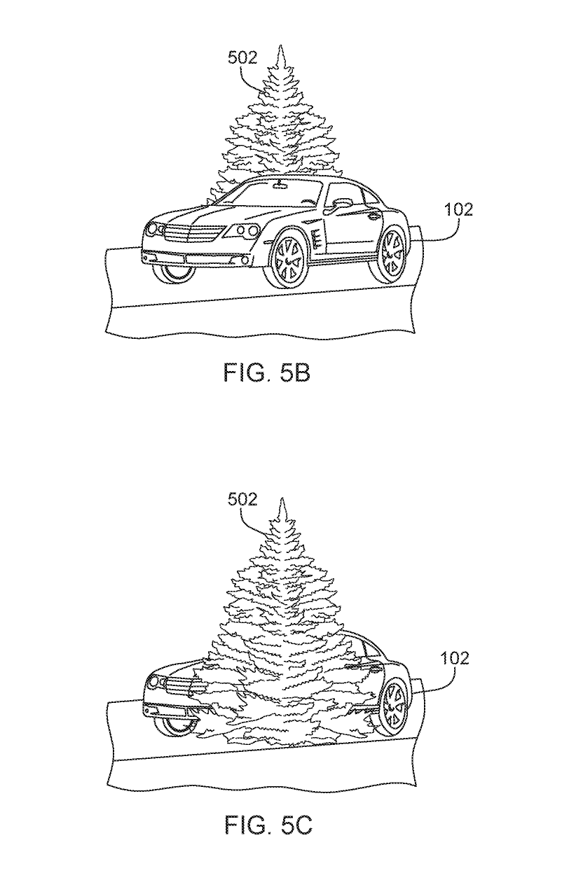

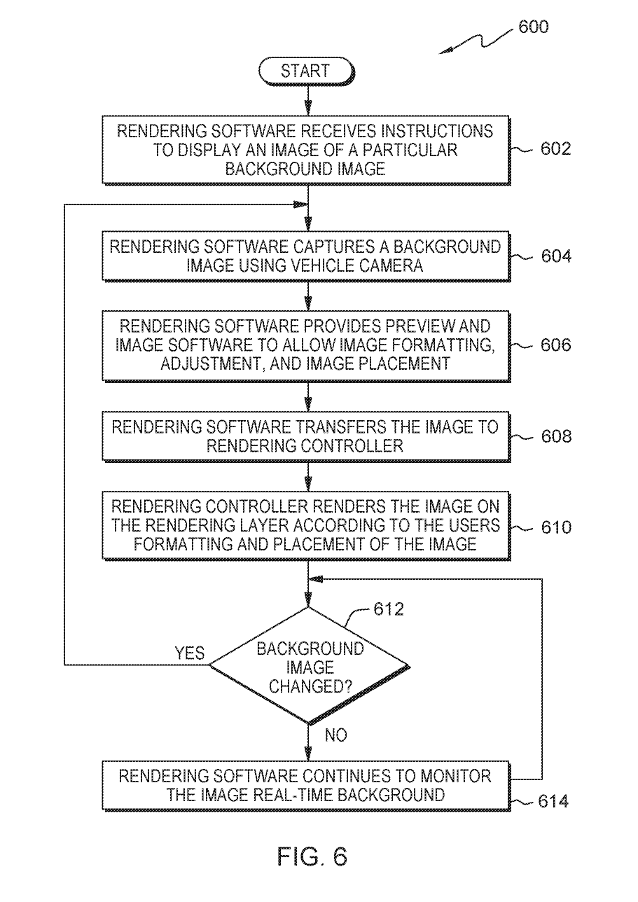

FIG. 6 is a flowchart, generally designated 600, depicting operational steps of a rendering software, on a vehicle within the image rendering environment of FIG. 1, for real time rendering of a background on a vehicle surface, in an embodiment in accordance with the present invention. In one example embodiment, a user decides to hide vehicle 102 by parking in front of tree 502 as depicted in FIG. 5A. Rendering software 118 receives instructions to display an image of a particular background image as depicted in step 602.

In step 604, rendering software 118 captures a background image using vehicle camera 110. For example, rendering software 118 may capture one or more images of tree 502 as the user positions vehicle 102 in the desired parking area or space. In another example embodiment, rendering software 118 may automatically move the car into the desired parking space while capturing images of tree 502 as depicted in FIG. 5B.

In some embodiments, rendering software 118 provides preview and image software to allow image formatting, adjustment, and image placement as depicted in step 606. For example, rendering software 118 may display the captured one or more images of tree 502 on user interface 304 as vehicle 102 moves into the parking space. Rendering software 118 also allows the user to modify, or format, the captured one or more images of tree 502. For example, the user may want to brighten the captured one or more images of tree 502 to make vehicle 102 blend in better with the surrounding area. In other embodiments, rendering software 118 may operate in an automatic and/or dynamic mode and bypass step 606. For example, rendering software 118 determines that vehicle 102 is moving and to prevent distracting a user rendering software 118 operates in an automatic mode. In another example, a user communicates to rendering software 118 that the user is leaving vehicle 102 unattended and that rendering software 118 utilizes one or more user preferences to respond to changes to a background image.

In step 608, rendering software 118 transfers the one or more images of tree 502 to rendering controller 302. Rendering controller 302 then determines how to place the one or more images of tree 502 in relation to the actual view of tree 502 as depicted in FIG. 5C. In one example embodiment, rendering software 118 may use camera 110 to capture a continuous video feed of tree 502 and the surrounding area. In other example embodiments, rendering software 118 may use camera 110 to update the displayed image of tree 502 at defined intervals.

Rendering controller 302 renders the image on rendering layer 114 according to the user's formatting and placement of the image as depicted in step 610. For example, the user may want the one or more images of tree 502 displayed in a certain way instead of using a real time image of tree 502.

In decision step 612, rendering software 118 determines if the one or more images of tree 502 have changed. For example, a small animal, such as a dog, moves past vehicle 102. If the one or more images of tree 502 have changed (“Yes” branch, decision 612), rendering software 118 repeats steps 604 through 612. If the one or more images of tree 502 have not changed (“No” branch, decision 612), rendering software 118 continues to monitor the real time image of tree 502 while comparing the image to the last captured image, or generated image, of tree 502 as depicted in step 614. This may be accomplished with any image analysis software known in the art.

In another example embodiment, a user of vehicle 102 may wear a smart watch, such as wearable device 308, which can monitor the user's body temperature, and pulse, to determine the user's current mood. Rendering software 118 may then change the color of vehicle 102 based on the measured body temperature and heart rate of the user. For example, the user may define one or more colors for one or more moods using wearable device 308 and configure a smart watch application to inform rendering software 118 to change the color displayed on rendering layer 114 based on the current mood. In cases where the user may be mad, vehicle 102 may display flames, whereas in cases when the user is happy, vehicle 102 may display tranquil colors with flowers.

In another example embodiment, rendering software 118 may display received SMS messages on rendering layer 114 of vehicle 102. SMS is a text messaging service component of phone, Web, or mobile communication systems. For example, a user may require roadside assistance due to a flat tire. While trying to change the tire the user may use mobile application 306 and/or wearable device 308 to send an SMS message to rendering software 118, indicating he/she requires help to passing drivers.

In another example embodiment, rendering software 118 may receive an indication from wearable device 308 indicating that the user of vehicle 102 is impaired. Rendering software 118 may display a symbol, image, or text on rendering layer 114 to warn other drivers of the user's impairment.

In another example embodiment, rendering software 118 may assist law enforcement in cases where vehicle 102 is stolen. Rendering software 118 may receive an SMS message from the user of vehicle 102, the authorities, or an anti-theft company to display an image, or text on rendering layer 114 indicating vehicle 102 is stolen.

In another example embodiment, where road and weather conditions may cause one or more accidents on a busy interstate, vehicles can wirelessly relay information back down a lane of traffic, or camera 110 may relay a message of a previous vehicle to the trunk/back door of the user's vehicle.

FIG. 7 depicts a block diagram, generally designated 700, of components of the computer executing the rendering software, in an embodiment in accordance with the present invention. It should be appreciated that FIG. 7 provides only an illustration of one implementation and does not imply any limitations with regard to the environments in which different embodiments may be implemented. Many modifications to the depicted environment may be made.

Vehicle 102 includes communications fabric 702, which provides communications between computer processor(s) 704, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer readable storage media. In this embodiment, memory 706 includes random access memory (RAM) 714 and cache memory 716. In general, memory 706 can include any suitable volatile or non-volatile computer readable storage media.

Operating system 116 and rendering software 118 are stored in persistent storage 708 for execution by one or more of the respective computer processors 704 via one or more memories of memory 706. In this embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 710, in these examples, provides for communications with other data processing systems or devices, including resources of network 120 and server 122, cell tower 132, and satellite 134. In these examples, communications unit 710 includes one or more network interface cards. Communications unit 710 may provide communications through the use of either or both physical and wireless communications links. Operating system 116 and rendering software 118 may be downloaded to persistent storage 708 through communications unit 710.

I/O interface(s) 712 allows for input and output of data with other devices that may be connected to vehicle 102. For example, I/O interface 712 may provide a connection to external devices 718 such as a keyboard, keypad, a touch screen, and/or some other suitable input device. External devices 718 can also include portable computer readable storage media such as, for example, thumb drives, portable optical or magnetic disks, and memory cards. Software and data used to practice embodiments of the present invention, e.g., operating system 116 and rendering software 118, can be stored on such portable computer readable storage media and can be loaded onto persistent storage 708 via I/O interface(s) 712. I/O interface(s) 712 also connect to a display 720.

Display 720 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Definitions

“Present invention” does not create an absolute indication and/or implication that the described subject matter is covered by the initial set of claims, as filed, by any as-amended set of claims drafted during prosecution, and/or by the final set of claims allowed through patent prosecution and included in the issued patent. The term “present invention” is used to assist in indicating a portion or multiple portions of the disclosure that might possibly include an advancement or multiple advancements over the state of the art. This understanding of the term “present invention” and the indications and/or implications thereof are tentative and provisional and are subject to change during the course of patent prosecution as relevant information is developed and as the claims may be amended.

“Embodiment,” see the definition for “present invention.”

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “plurality of” items means there exists at more than one item; there must exist at least two items, but there can also be three, four, or more items.

“Includes” and any variants (e.g., including, include, etc.) means, unless explicitly noted otherwise, “includes, but is not necessarily limited to.”

A “user” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” and “output,” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “computer” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

“Automatically” means “without any human intervention.”

The term “real time” includes any time frame of sufficiently short duration as to provide reasonable response time for information processing as described. Additionally, the term “real time” includes what is commonly termed “near real time,” generally any time frame of sufficiently short duration as to provide reasonable response time for on-demand information processing as described (e.g., within a portion of a second or within a few seconds). These terms, while difficult to precisely define, are well understood by those skilled in the art.

What is claimed is:

1. A computer-implemented method comprising:
providing, by one or more computer processors, a programmable display covering a portion of a surface of an object, wherein the programmable display is an e-ink display that does not include a backlight, and wherein the programmable display includes a flexible rendering layer that flexes to match the contours and edges of the portion of the surface of the object;
receiving, by one or more computer processors, a set of desired features for an appearance of the object from a user using a user interface, wherein a desired feature of the set of desired features is to conceal the object;
capturing, by one or more computer processors, an image of a view behind the object;
generating, by one or more computer processors, an image of the portion of the surface of the object incorporating the set of desired features, wherein the captured image of the view behind the object is used in generating the image of the portion of the surface of the object;
modifying, by one or more computer processors, the generated image based, at least in part, on a determined location of the object;
displaying, by one or more computer processors, the generated image on the programmable display, thereby causing the object to appear to have the desired features;
continuously monitoring, by one or more computer processors, the view behind the object to determine one or more changes between the captured image of the view behind the object and the view behind the object; and
upon determining one or more changes between the captured image of the view behind the object and the view behind the object, updating the generated image displayed on the programmable display based on the one or more changes between the captured image of the view behind the object and the view behind the object.
